(19) United States
(12) Patent Application Publication
(10) Pub. No.: US 2026/0281833 A1
(43) Pub. Date: Sep. 17, 2026

(54) INTELLIGENT OPTIMIZATION FOR DUAL CONNECTIVITY IN WIRELESS COMMUNICATION SYSTEMS

(71) Applicant: ZTE CORPORATION, Shenzhen (CN)

(72) Inventors: Jiajun CHEN, Shenzhen (CN); Yingjun ZHOU, Shenzhen (CN); Dapeng LI, Shenzhen (CN); Yin GAO, Shenzhen (CN)

(21) Appl. No.: 19/168,071

(22) PCT Filed: Mar. 24, 2023
(86) PCT No.: PCT/CN2023/083777

§ 371 Date: Sep. 23, 2025

(51) Int. Cl. H04W 36/00; H04L 41/16; H04W 76/30

(52) U.S. Cl. CPC H04W 36/0069; H04L 41/16; H04W 76/30

(57) ABSTRACT

A method, network device and storage medium for DC in cellular wireless communication systems are disclosed. A master node (MN) may provide predicted User Equipment (UE) trajectory and other predicted MN or Secondary Node (SN) information inferred from one or more AI/ML models to the SN for the SN to effectuate addition, selection, configuration, modification, change, and/or removal of resources, primary cells, secondary cells, cell groups, and the like to optimize DC. Likewise, the SN may provide predicted UE trajectory and other predicted information of itself and other target SNs inferred from one or more AI/ML models to the MN to effectuate changes and optimization in DC configuration and selection of target SN and target cells therein. Various mechanisms based on expanding existing MN-SN messaging framework or new MN-SN messaging framework are disclosed in order to effectuate the transfer of the AI predictions for DC optimization.

### CROSS-REFERENCE TO RELATED APPLICATION

This application is a national stage filing under 35 U.S.C. § 371 of international application number PCT/CN 2023/083777, filed Mar. 24, 2023, the contents of which are incorporated herein by reference in its entirety.

### TECHNICAL FIELD

The present disclosure is generally directed to wireless dual connectivity (DC) and specifically directed to methods and network devices for DC in cellular wireless communication systems assisted by prediction of network conditions using Artificial Intelligence (AI) and/or Machine Learning (ML) models.

### BACKGROUND

In a cellular wireless communication system, a wireless terminal may be simultaneously connected to multiple base stations. For example, the wireless terminal may be connected to two base stations of distinct radio access technologies. Such mode of communication may be referred to as dual connectivity (DC). The two base stations may operate in a collaborative and intelligent manner in performing network configuration and in providing data connectivity to the wireless terminal device.

### SUMMARY

The present disclosure is generally directed to wireless dual connectivity (DC) and specifically directed to methods and network devices for DC in cellular wireless communication systems assisted by prediction of network conditions using Artificial Intelligence (AI) and/or Machine Learning (ML) models. For example, a master node (MN) may provide predicted User Equipment (UE) trajectory and other predicted MN or Secondary Node (SN) information inferred from one or more AI/ML models to the SN for the SN to effectuate addition, selection, configuration, modification, change, and/or removal of resources, primary cells, secondary cells, cell groups, and the like to optimize DC. Likewise, the SN may provide predicted UE trajectory and other predicted information of itself and other target SNs inferred from one or more AI/ML models to the MN to effectuate changes and optimization in DC configuration and selection of target SN and target cells therein. Various mechanisms based on expanding existing MN-SN messaging framework or new MN-SN messaging framework are disclosed in order to effectuate the transfer of the AI predictions for DC optimization.

In some example implementations, a method performed by a first base station (BS) for supporting a dual over-the-air connectivity (DOTA), in conjunction with a second BS, to a wireless terminal is disclosed. The first BS and the second BS are respectively one and another of a master node (MN) and a secondary node (SN). The method may include generating a first network configuration prediction information according to one or more pre-trained Artificial Intelligence (AI) models; and transferring the first network configuration prediction information in an inter-BS message to the second BS to assist the second BS with the DOTA with the wireless terminal, the inter-BS message carrying the first network configuration prediction information. The first network configuration prediction information may include at least one of: predicted PSCell information of the SN or a target SN for the DOTA with the wireless terminal; predicted PCell information of the MN for the DOTA with the wireless terminal; predicted location information of the wireless terminal; predicted target S-NG-RAN node list; or a predicted target M-NG-RAN node list.

In some other example implementations, a method performed by a first base station (BS) for supporting a dual over-the-air connectivity (DOTA), in conjunction with a second BS, to a wireless terminal is disclosed. The first BS and the second BS are respectively one and another of a master node (MN) and a secondary node (SN). The method may include: receiving a request message for Artificial Intelligence (AI) generated DOTA configuration assistance information. In response to the request message and to determining that the first BS is successfully configured to generate the AI generated DOTA configuration assistance information as requested: generating the AI generated DOTA configuration assistance information; and transmitting a response message containing the AI generated DOTA configuration assistance information to the second BS. In response to the request message and to determining that the first BS fails to generate the AI generated DOTA configuration assistance information, transmitting a failure response to the second BS. The AI generated DOTA configuration assistance information may include at least one of: predicted PSCell information of the SN or a target SN for the DOTA with the wireless terminal; predicted PCell information of the MN for the DOTA with the wireless terminal; predicted location information of the wireless terminal; a predicted target S-NG-RAN node list; or a predicted target M-NG-RAN node list.

In some other implementations, a wireless device comprising a processor and a memory is disclosed. The processor may be configured to read computer code from the memory to implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or UEs and a wireless access network node in communication with one another via an over-the-air radio communication interface.

FIG. 3 shows an exemplary radio access work configured with multiple cells for supporting dual connectivity.

FIG. 4 shows an example MN-initiated SN addition or modification procedure for AI/ML assisted dual connectivity.

FIG. 5 shows an example SN-initiated SN modification or change procedure for AI/ML assisted dual connectivity.

FIG. 6 shows an example MN-initiated SN release procedure for AI/ML assisted dual connectivity.

FIG. 7 shows an example SN-initiated SN release procedure for AI/ML assisted dual connectivity.

FIG. 8 shows an example SN-initiated AI/ML assistance information request procedure for dual connectivity.

FIG. 9 shows an example MN-initiated AI/ML assistance information request procedure for dual connectivity.

### DETAILED DESCRIPTION

The technology and examples of implementations and/or embodiments described in the present disclosure can be used to facilitate transmitting and receiving Artificial Intelligence (AI) network management models between various wireless network devices or nodes via at least one over-the-air interface. The term “over-the-air interface” is used interchangeably with “air interface” or “radio interface” in the present disclosure. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of the present disclosure or claimed subject matter is intended to be construed as not being limited to any of the embodiments set forth below. The various implementations may be embodied as methods, devices, components, systems, or non-transitory computer readable media. Accordingly, embodiments of the present disclosure may, for example, take the form of hardware, software, firmware or any combination thereof.

The present disclosure is generally directed to wireless dual connectivity (DC) and specifically directed to methods and network devices for DC in cellular wireless communication systems assisted by prediction of network conditions using Artificial Intelligence (AI) and/or Machine Learning (ML) models. For example, a master node (MN) may provide predicted User Equipment (UE) trajectory and other predicted MN or Secondary Node (SN) information inferred from one or more AI/ML models to the SN for the SN to effectuate addition, selection, configuration, modification, change, and/or removal of resources, primary cells, secondary cells, cell groups, and the like to optimize DC. Likewise, the SN may provide predicted UE trajectory and other predicted information of itself and other target SNs inferred from one or more AI/ML models to the MN to effectuate changes and optimization in DC configuration and selection of target SN and target cells therein. Various mechanisms based on expanding existing MN-SN messaging framework or new MN-SN messaging framework are disclosed in order to effectuate the transfer of the AI predictions for DC optimization.

### Cellular Wireless Network Overview

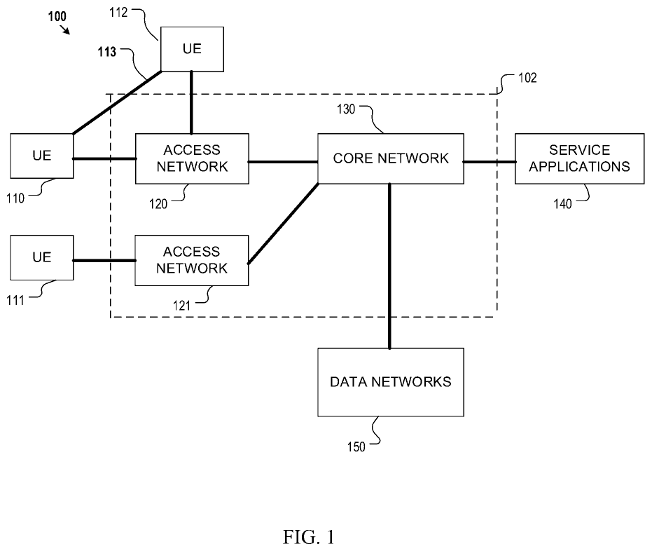

An example cellular wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer to a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

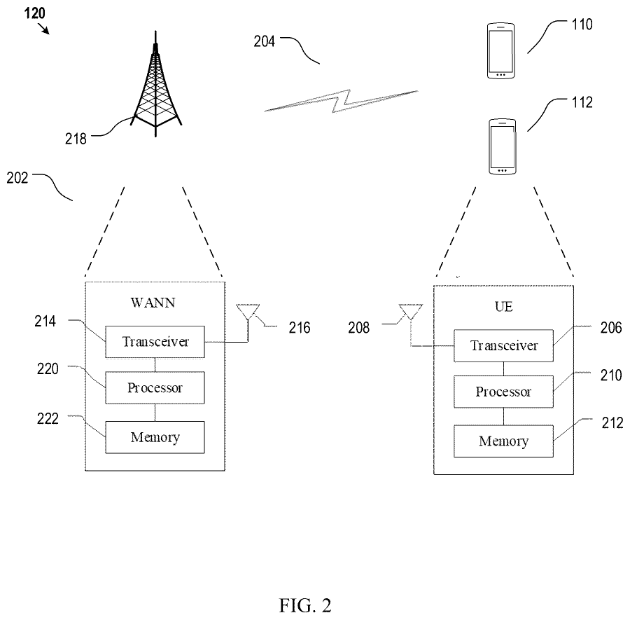

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point or node capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

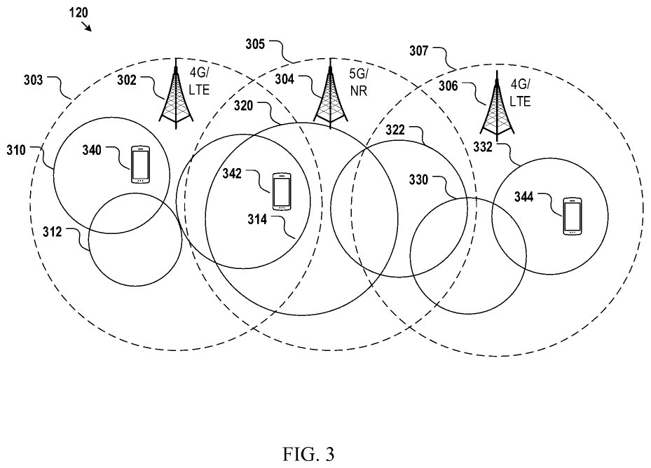

The example wireless access network or radio access network above may be configured as a cellular network, in which radio communication resources are managed in cells. The communication cells are configured to minimize radio interference. As shown in the wireless access network 120 in FIG. 3, each base station 302, 304, and 306 may be associated with a particular Radio Access Technology (RAT). The various RATs may include but not limited to 2G, 3G, 4G/LTE, 5G, 6G, and other generations of radio access technologies. The term base station is used to refer to a network node or a portion of a network node that communicates with wireless terminals using one or more OTA interfaces. In wireless access network nodes having functional split, such as a split between distributed units (DUs) and central units (CUs), the term base station may be used refer to a DU. The base stations 302, 304, and 306 may use separate or shared radio resources (e.g., carrier frequencies and/or time). Each of the base stations may be associated with a coverage area, which may include one or more cells. For example, as shown in FIG. 3, the base station 302 may be a 4G/LTE base station associated with an approximate coverage area 303 and configured to provision cells 310, 312 and 314; the base station 304 may be a 5G/New Radio (NR) DU associated with approximate coverage area 305 and configured to provision cells 320 and 322; whereas the base station 306 may be another 4G/LTE base station associated with an approximate coverage area 307 and configured to provision cells 330 and 332.

The wireless terminals 340, 342. and 344 in FIG. 3, for example, may be mobile wireless terminals and thus may move from cell to cell and/or from RAT to RAT. A particular wireless terminal may be potentially connected to multiple cells or multiple RAT. Dual connectivity (DC) (or multi-connectivity) refers to network implementations where a wireless terminal is simultaneously connected to two (or multiple) cells of two (or multiple) distinct RATs. For example, the wireless terminal 342 of FIG. 3 may be configured to be in DC operation m mode with cell 414 (provisioned by the 4G/LET base station 302) and cell 320 (provisioned by the 5G/NR base station 304).

The multiple cells shown in FIG. 3 for each base station may be configured into cell groups (CGs). Both the cells and CGs are provisioned (e.g., added, configured, modified removed, etc.) by the corresponding base station. A cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCells. The primary cells including PCell and PScell may be collectively referred to as spCells (special Cells). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

### Dual Connectivity

In some example implementations as described above, a wireless terminal such as 342 in FIG. 3, may be in active connection with two base stations having distinct RATs (e.g., 4G/LTE and 5G/NR technologies in the example of FIG. 3). The communications with the two base stations may be via distinct carrier spectral bands allocated to the two distinct RATs. However, in some example implementations, the two distinct RATs may share a radio spectrum or have overlapping radio spectrum using, for example Dynamic Spectrum Sharing (DSS) technologies. One of the two base stations in dual connectivity, for example, may act as a master, referred to as a Master Node (MN), whereas the other base station may act as a Secondary Node (SN). The MN and the SN may communicate via various messages over separate communication interface(s) (e.g., a backhaul interface) to effectuate a collaborative effort to configure the cells, CGs, and communication resources within the MN and SN in providing optimal dual connectivity to the mobile terminal, and to facilitate cell switching within the MN and SN or outside of the MN or SN for the mobile terminal when needed.

### AI Assistance in Wireless Network Configuration

In some example implementations, network configurations, particularly in relation to resource allocation, cell selection and configuration, and the like in radio access networks, may be assisted using Artificial Intelligence (AI) or Machine Learning (ML) models to anticipate or predict future network conditions. For example, AI models may be used for UE trajectory (e.g., UE locations, movement directions) prediction and thereby assist in mobility optimization in serving cell selection and switching and resource configuration and allocation therein, all in advance.

As such, at the core of a general AI network management framework are various AI models. An AI model generally contains a large number of model parameters that are determined through a training process where correlations in a set of training data are learned and embedded in the trained model parameters. The trained model parameters may thus be used to generate inference from a set of input dataset that may not have existed in the training dataset. AI models are particularly suitable for situations where there is few trackable deterministic, rule-based, or analytical derivation paths between input data and output.

In a wireless communication system such as the ones described above, determination of adaptive network configuration may rely on empirical characteristics and my further require lengthy measurement processes and/or significant amounts of computation power. Such types of configurations may include but are not limited to over-the-air interface beam management, channel state information (CSI) feedback compression and decompression, and wireless terminal positioning. Correlation between various network conditions and these adaptive configurations may be leaned via AI techniques. The use of AI models for assisting in network configuration may thus help reduce the amount of measurements and computation requirement, providing a more agile network configuration.

For example, AI technology may be applied to beam management in the over-the-air communication interface. In current implementations, beam management typically relies on the exhaustive searching beam sweeping. In other words, the network (NW) may perform a full sweep of the beams by sending sufficient number of reference signals. A UE may be configured to monitor and measure each reference signal and then report the measurement result to NW for the NW to decide the best beam for the UE to switch to. This process, however, is resource and power intensive. With trained AI models that embed learned correlation between various network condition parameters, few measurements (or fewer reference signals) may be needed in order to accurately infer the best beams. In some implementations, AI model may help identify inference of best candidate beams using other network conditions and then only sweep and measure the candidate beams to select the beam for use in current communication. Additionally, as beam configuration is closed tied to a location of the UE, AI technology may further be used for inferring or predicting UE trajectory or location, thereby indirectly help selection of best beams.

For another example, AI technology may be applied to channel state information (CSI) feedback. Traditionally, the CSI feedback may be implemented using a codebook known by UE and NW. The UE may measure the CSI and obtain a measurement result, and then map the measurement result to a closest vector of the codebook, and transmit the index of that vector to the NW in order to save the air-interface resource consumption. However, because the codebook is not unlimited or dynamic changeable over time, there would be always mismatch, thereby causing un-controlled CSI feedback errors as the wireless environment varies. AI thus may be applied to compression-decompression for CSI feedback. Specifically, a CSI report may be compressed by a UE-side AI model and decompressed by a corresponding NW-side AI model. Such AI models may be initially trained and continuously developed over time and accumulation of network conditions.

For yet another example, and as generally described above, AI technology may be applied to UE positioning. Traditional approaches for UE positioning depend on PRS or SRS (e.g. DL Positional Reference Signal and uplink Sounding Reference Signal). Regardless of the alternative approaches, the LOS (Line-Of-Sight) beams are the key beams to identify in order to generate the most precise location estimation by triangulation at the NW side. However, in most case, it is difficult to identify the LOS beams from other NLOS (Non-Line-Of-Sight) beams, thereby providing in accurate UE positioning. A trained AI model, on the other hand, may identify various pattern and correlation in the PRS and SRS for extracting LOS information and providing more accurate UE positioning.

These AI/ML models may be trained and managed at the various network nodes described above, and may need to be delivered or transferred to another network nodes. For AI models that may be relied on for purpose of assisting with dual connectivity, they may reside on either an MN or an SN. These AI/ML models may be trained, retrained, updated at the MN or SN and used to perform prediction or inference at the MN or SN. Alternatively, these AI/ML models may be trained, retrained, updated in some other network nodes (such as Operation Administration and Maintenance (OAM) nodes in the core network) and then delivered to the MN or SN to perform prediction or inference at the MN or SN. In some other implementations, rather than residing at the MN or SN, these AI/ML models may reside in other network nodes (such as Operation Administration and Maintenance (OAM) nodes in the core network), which may receive input data from the MN or SN, perform prediction and then communicate prediction outcome to the MN or SN. In the RAN network having CU-DU split, theses AI/ML models may be trained and located in the CUs or trained in OAMs and delivered to the CUS for performing prediction or inference at the CUS. Alternatively, these AI/ML Model may be training at the CUs or OAMs and delivered to the DUs, and the AI/ML Model prediction and inference function may be located in DUs.

In the various DC example implementations below, the MN may provide predicted UE trajectory and other predicted MN or SN information via one or more AI/ML models to the SN for the SN to effectuate addition, selection, configuration, modification, change, and/or removal of resources, primary cells, secondary cells, cell groups, and the like in support of the DC. Likewise, the SN may provide predicted UE trajectory and other predicted information of itself and other target SNs via one or more AI/ML models to the MN for the effectuate changes and optimization in DC configuration and selection of target SN and target cells therein. Various mechanisms based on expanding existing MN-SN messaging framework or new MN-SN messaging framework are disclosed below in order to effectuate the transfer of the AI predictions for DC optimization.

### Transmitting AI/ML Prediction Information in MN-Initiated SN Addition Procedure

SN addition preparation procedure may be implemented to request an SN to allocate resources for DC operation for a specific UE (or wireless terminal). Such request may be transmitted from an MN to the SN via an MN-SN interface, e.g., MN-SN backhaul interface. Such a request may be transmitted by the MN in a form of a SN Addition Request Message. Such SN Addition Request Message may be used by the SN to establish a UE context at the SN and provide radio resources from the SN to the UE. This SN addition procedure at the SN may be used to add at least a first cell of a Secondary Cell Group (SCG) at the SN.

In some example implementation, the SN Addition Request Message may include information item(s) that indicates the requested SCG configuration information, including but not limited to entire capabilities of the mobile terminal and the UE capability coordination result. In some example implementations, the MN may further provide, via the SN Addition Request, latest network measurement results for SN to choose and configure the SCG cell(s). Via the SN Addition Request Message, the MN may further request the radio resources for split Signaling Radio Bearer (SRB) operation. The MN also provides the needed security information to the SN (even if no SN terminated bearers are setup) to enable SRB (e.g., SRB3) to be set up based on SN decision. In case of bearer options that require X2-U resources between the MN and the SN, the MN may further provide X2-U TNL address information for the respective E-RAB, X2-U DL TNL (DownLink Transport Network Layer) address information for SN terminated bearers, and X2-U UL TNL (UpLink Transport Network Layer) address information for MN terminated bearers. In case of SN terminated split bearers, the MN may further provide the maximum QoS level that it can support.

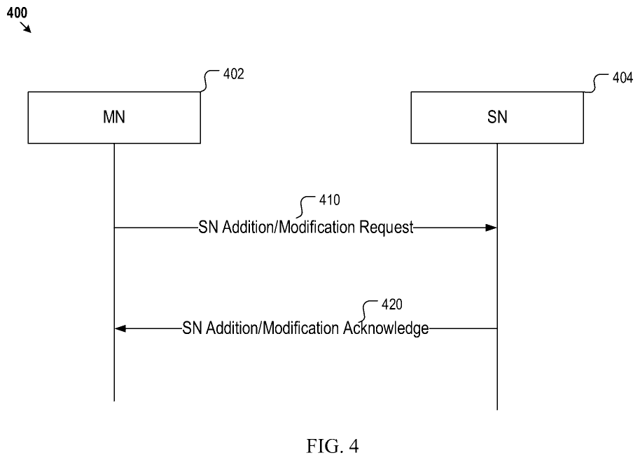

In some example implementations, the MN may provide the AI/ML based predicted information for the SN to choose from and configure the SCG cell(s) via the SN Addition Request Message above, as shown in the example SN addition preparation procedure 400 of FIG. 4.

As shown in FIG. 4, the SN addition preparation procedure 400 may include Step 1 (410) and Step 2 (420) for message exchange between the MN 402 and SN 404.

In Step 1, as shown by 410, the MN 402 may send the SN Addition Request Message to the SN 404. The SN Addition Request Message, among other information items described above, may include one or more of the following:
AI/ML Prediction information items relevant to trajectory of the mobile terminal; and/or
An indicator, referred to as AI/ML-based-assistance-information-allowed-Indicator for indicating whether the SN 404 needs to provide AI/ML based prediction information from the SN 404 to the MN 402 in response to the SN Addition Request Message.

The AI/ML prediction information items above may be obtained or generated at the MN 402 prior to being included in the SN Addition Request message for transmission to the SN 404. Such AI/ML prediction information items may be generated via an inference process using AI/ML model residing at the MN 402 and measurement data directly or indirectly collected at the MN 402. Alternatively, the AI/ML prediction information items may be obtained by the MN 402 from inference procedure in other network nodes (e.g., OAMs). In some other information, the AI/ML prediction information may be a mix of the above.

In some example implementations, the AI/ML prediction information items may include one or more of the following:
A predicted target S-NG-RAN node List;
A predicted PSCell List for the SN;
A predicted Target M-NG-RAN node List;
A predicted PCell List of the MN; and/or
A predicted UE location List.

The Predicted PSCell List for the SN, for example, may further include one or more of the following information:
Predicted PScell IDS of the SN;
A predicted arrival time of the wireless terminal at each predicted PSCell;
A predicted duration time of the UE staying in the PScell;
Probability of each predicted PSCell being a candidate PSCell; and/or
Validity time, which means the predicted value is valid for a certain period of time.

The Predicted PCell List for the UE in the MN, for example, may further include one or more of the following information:
Predicted PCell IDs of the MN;
Predicted arrival time of the UE at each predicted PCell;
Predicted duration time of UE staying in the PCell;
Probability of each predicted PCell being a candidate PCell; and/or
Validity time, which means the predicted value is valid for a certain period of time.

The predicted UE location List, for example, may further include one or more of the following information:
Predicted UE coordinates in the future;
A predicted arrival time of the UE at each predicted coordinate;
A predicted duration time of UE staying in the current coordinate;
Confidence of each predicted future coordinate; and/or
Validity time, which means the predicted value is valid for a certain period of time.

As further shown by 420 in FIG. 4, in Step 2, the SN 404 may generate and send a response message to the MN 402 for acknowledging the SN Addition Request from the MN 402 after receiving the Request. In some example implementations, if the MN 402 has indicated in the SN Addition Request that AI/ML prediction information from the SN 404 is needed, the SN 404 may further generate and include such AI/ML prediction information in the response message in 420 to the MN 402.

### Transmitting AI/ML Prediction Information in MN-initiated SN Modification Procedure

In some example implementations, SN modification preparation procedure may be initiated by the MN to modify, establish, or release bearer context, to transfer bearer contexts to and from the SN or to modify other properties of the UE context within the same SN, or to query the current SCG configuration for supporting delta signaling in MN-initiated SN node change. It may also be used to transfer an RRC message from the SN to the wireless terminal via the MN.

Specifically, the MN may use this procedure to initiate configuration changes of the SCG within the same SN, e.g. the addition, modification or release of SCG bearer(s) and the SCG RLC (Radio Link Control) bearer of split bearer(s), as well as configuration changes for SN terminated MCG bearers. Bearer type change may result in adding the new bearer configuration and releasing the old bearer configuration within a single MN-initiated SN modification procedure. The MN may also use this procedure to perform handover within the same MN while keeping the SN. The MN may also use this procedure to query the current SCG configuration, e.g. when delta configuration is applied in an MN-initiated SN change. The MN may further use the procedure to provide the S-RLF (Secondary Radio Link Failure) related information to the SN.

For the SN modification procedure, the MN may send the SN an SN Modification Request Message, which may contain bearer context information related to the mobile terminal or other context related information of the mobile terminal, data forwarding address information (if applicable) and the requested SCG configuration information, including the UE capability coordination result to be used as basis for a reconfiguration by the SN.

In some example implementations, when the AI/ML predicted information obtained or generated by MN is updated, the MN can provide the updated AI/ML based predicted information for the SN to choose from and configure the SCG cell(s) via the SN Modification Request Message, above, as also shown in the example SN addition preparation procedure 400 of FIG. 4.

The SN modification procedure 400 incorporating the AI/ML prediction information is similar to that of the SN addition procedure described above also in relation to FIG. 4. The example two steps shown in FIG. 4 for the SN modification procedure is similar to those described above for the SN addition procedure and are thus not duplicate here. The SN Modification Request Message from the SN may include the AI/ML predicted information items and the AI/ML-based-assistance-information-allowed-Indicator described above for indicating whether SN needs to provide AI/ML based prediction information from the SN 404 to MN 402 in response to the SN addition modification message. The AI/ML predicted information items may be similar to the information items described above for the SN addition request.

### Transmitting AI/ML Prediction Information in SN-Initiated SN Modification Procedure

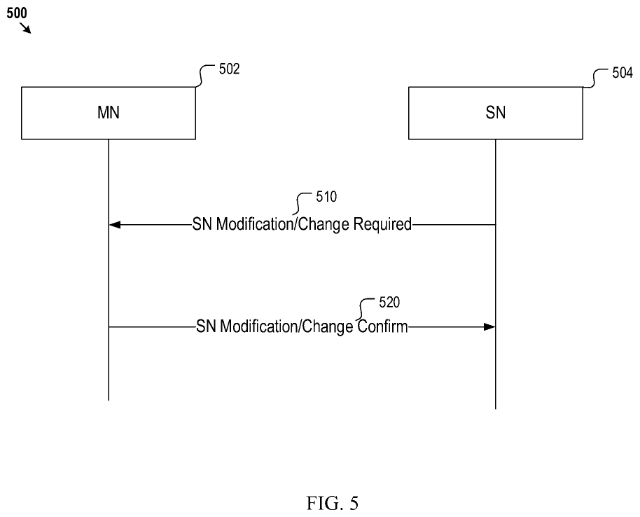

In some example implementations, the SN modification procedure described above may be initiated by the SN rather than the MN, as shown in FIG. 5. For example, the SN 504 may initiate the SN modification procedure by sending an SN Modification Required Message to the MN in 510. The purposes for the SN modification and the various information items included in the SN Modification Required Message may be similar to those of the MN-initiated SN Modification Request described above in relation to FIG. 4.

For AI/ML prediction information, the SN may first obtain or generate AI/ML predictions at the SN 504 prior to including the prediction in the SN Modification Required Message for transmission to the MN 502. As specifically shown in 510 of FIG. 5, in Step 1, the SN 504 may send the SN Modification Required Message to the MN 502, for providing updated AI/ML predicted information. The SN Modification Required Message, among other information items described above, may include one or more of the following:
AI/ML Prediction information items relevant to trajectory of the mobile terminal; and/or
An indicator, referred to as AI/ML-based-assistance-information-allowed-Indicator for indicating whether the MN 502 needs to provide AI/ML based prediction information from the MN 502 to the SN 404 in response to the SN Modification Required Message.

Such AI/ML prediction information items may be generated via an inference process using AI/ML model residing at the SN 504 and measurement data directly or indirectly collected at the SN 502. Alternatively, the AI/ML prediction information items may be obtained by the SN 504 from inference procedure in other network nodes (e.g., OAMs). In some other example implementations, the AI/ML prediction information may be a mix of the above.

In this case, the SN may provide the predicted information of the SN for MN to configure the SCG(s). In some example implementations, the AI/ML prediction information items may include one or more of the following:
A predicted PSCell List for the SN;
A predicted Target S-NG-RAN node List; and/or
A predicted UE location List.

The Predicted PSCell List for the SN, for example, may further include one or more the information items described above in relation to FIG. 4. Likewise, the Predicted UE location List, for example, may further include one or more of the information items described above in relation to FIG. 4.

As further shown by 520 in FIG. 5, in Step 2, the MN 502 may generate and send a confirmation message to the SN 504 for acknowledging the SN Modification Required Message from the SN 504 after receiving the message. In some example implementations, if the SN 504 has indicated in the SN Modification Required Message that AI/ML prediction information from the MN 502 is needed, the MN 502 may further generate and include such AI/ML prediction information in another message to the SN 504.

### Transmitting AI/ML Prediction Information in SN-Initiated SN Change Procedure

In some example implementations, an SN change procedure may be initiated by the SN to request the MN to switch to a target SN. For example, the current source SN may initiate at the SN the SN change procedure by sending an SN Change Required Message to the MN. Such a message may include an identifier of the target SN and may further include SCG configuration (to support delta configuration) and measurement results related to the target SN.

In some example implantations, AI/ML prediction information related to the target SN may be generated or obtained by the source SN and included in the SN-initiated SN Change Required Message, as shown in FIG. 5

The example steps for implementing the SN-initiated SN change procedure is similar to those described above for the SN-initiated SN modification procedure also in relation to FIG. 5.

Likewise, the AI/ML prediction information items included in the SN-initiated SN Change Required Message may be similar to those included in the SN-initiated SN Modification Required Message described above, except that the Predicted PSCell information items may be associated with the target SN rather than the current source SN.

### Transmitting AI/ML Prediction Information in MIN-Initiated SN Release Procedure

In some example implementations, the MN may initiate an SN release procedure to release resources for a specific mobile terminal. The SN, in response to the request, can provide AI/ML based predicted information related to the SN to the MN so that MN can choose a proper new SN or provide measurements to the new SN to configure its SCG(s) in order to optimize dual connectivity.

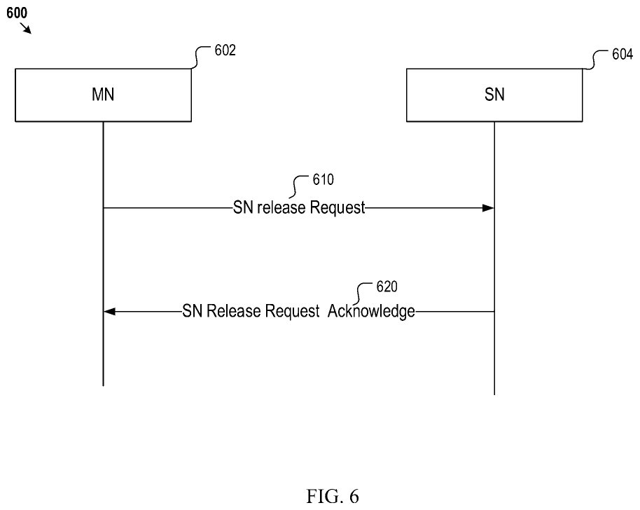

An example MN-initiated SN release procedure is illustrated in 600 of FIG. 6 involving the MN 602 and SN 604. In some implementations, the MN-initiated SN release procedure may include Step 1 (610) and Step 2 (620) for message exchange between the MN 602 and SN 604.

In Step 1, as shown by 610, the MN 602 may send an SN Release Request Message to the SN 604.

In Step 2, as shown by 620, the SN 604, in receiving the SN Release Request Message, may respond with an SN Release Request Acknowledge Message to the MN 602.

The SN Release Request Acknowledge Message may include, among other information items, the AI/ML prediction information items. The AI/ML prediction information items may be generated or obtained at the SN and may include predictions relevant to mobile terminal trajectory, including but not limited to:
A predicted PSCell List for the SN;
A predicted Target S-NG-RAN node List; and/or
Predicted UE location List.

The Predicted PSCell List may be relevant to the target SN, and, for example, may further include one or more the information items pertaining to the target SN as described above in relation to FIG. 4. Likewise, the Predicted UE location List, for example, may further include one or more of the information items described above in relation to FIG. 4.

### Transmitting AI/ML Prediction Information in SN-Initiated SN Release Procedure

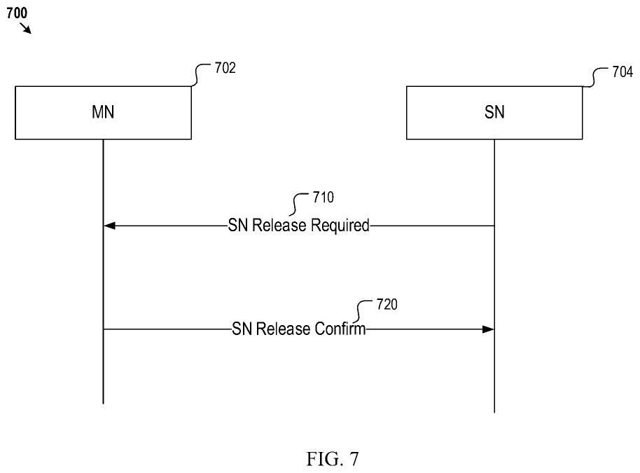

In some example implementations, the above SN release procedure may be triggered or initiated by the SN rather than the MN for releasing resources for a particular mobile terminal, as shown by 700 of FIG. 7.

The example SN-initiated SN release procedure 700 of FIG. 7 may include Step 1 (710) and Step 2 (720) for message exchange between the MN 702 and SN 704.

In Step 1, as shown in 710 of FIG. 7, the SN 704 may initiate the SN release procedure by sending an SN Release Required Message to the MN 702. The SN Release Required Message may include, among other information items, AI/ML predicted information related to mobile terminal trajectory similar to that included in Step 2 of FIG. 6 and described in further detail above.

In Step 2, as shown in 720 of FIG. 7, the MN 702 may, upon receiving the SN Release Required Message from the SN 704, send an SN release confirmation message to the SN 704. The MN may then proceed to use the AI/ML information items sent from the SN 704 for target SN selection and cell selection and configuration thereof for an optimization of dual connectivity.

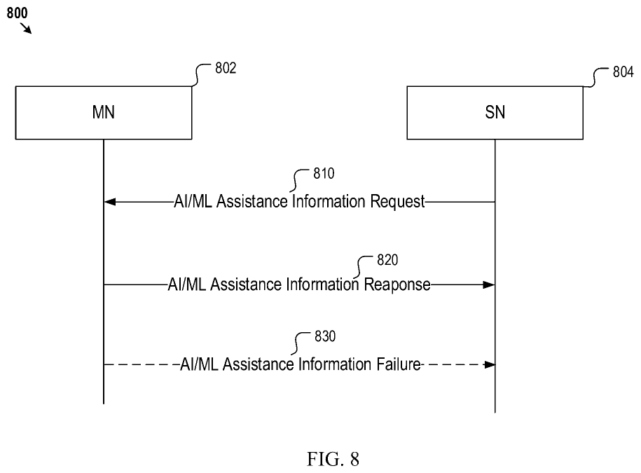

SN-Initiated AI/ML Prediction Information Request and Transmission Procedure In some example implementation, a procedure may be designed for requesting AI/ML prediction information between the MN and the SN. For example, such AI/ML prediction information request procedure may be initiated by the SN. Such an example procedure is shown in 800 of FIG. 8. The SN-initiated AI/ML prediction information request procedure may include Step 1 (810), optional Step 2 (820), and optional Step 3 (830) for message exchange between the MN 802 and SN 804.

In Step 1, as shown in 810 of FIG. 8, the SN 804 may send an AI/ML Assistance Information Request Message to the MN 802, for requesting the AI/ML predicted information from the MN 802. Such an AI/ML Assistance Information Request Message may, among other information items, include one or more of the following information items:
An identifier of the mobile terminal assigned or allocated at the SN 804, e.g., SN-assigned UE XnAP ID; and/or
A type for the requested AI/ML assistance information.

The type for the requested AI/MI assistance information may indicate a category of AI/MI assistant information that the SN 804 intends to request from the MN 802, and may indicate that the AI/MI assistant information items are the ones relevant to predicted UE trajectory.

In Step 2, as shown in 820 of FIG. 8, the MN 802, upon receiving the AI/ML Assistance Information Request Message, may determine whether it is configured or in a position to successfully provide the requested AI/MI assistance information. If the MN 802 determines that it is configured to in the position of successfully obtaining or generating the requested AI/ML assistance information, it then obtains or generates the requested AI assistance information via inference procedures and sends an AI/ML Assistance Information Response Message to the SN 804. Such an AI/ML Assistance Information Response Message may include and provide the request AI/ML assistance information items. The AI/ML Assistance Information Response Message, for example, may include at least one of the following information:
An identifier for the mobile terminal as assigned or allocated at the SN 804, e.g., an XnAP ID for the mobile terminal at the SN 804;
An identifier for the mobile terminal as assigned or allocated at the MN 802, e.g., an XnAP ID for the mobile terminal at the MN 802; and/or
The AI/ML predicted information items relevant to the trajectory of the mobile terminal.

The AI/ML predicted information items relevant to the trajectory of the mobile terminal may include the following prediction information related to the SN 804 or a target SN:
A predicted PSCell List for the SN or the target SN;
A predicted PCell List for the MN;
A predicted Target S-NG-RAN node List;
A predicted Target M-NG-RAN node List; and/or
A predicted UE location List.

The Predicted PSCell List may be relevant to current SN 804 or the target SN, and, for example, may further include one or more the information items pertaining to the SN 804 or the target SN as described above in relation to FIG. 4. Likewise, the predicted PCell List for the MN 804 and Predicted UE location List, for example, may further include one or more of the information items described above in relation to FIG. 4.

Optionally or alternatively in Step 3, as shown by 830 of FIG. 8, if the MN 802 determines that it is not in a position or is not configured to successfully obtain or generate the request AI/ML assistance information items, it then sends an AI/ML Assistance Information Failure Message to the SN 804.

### MN-Initiated AI/ML Prediction Information Request and Transmission Procedure

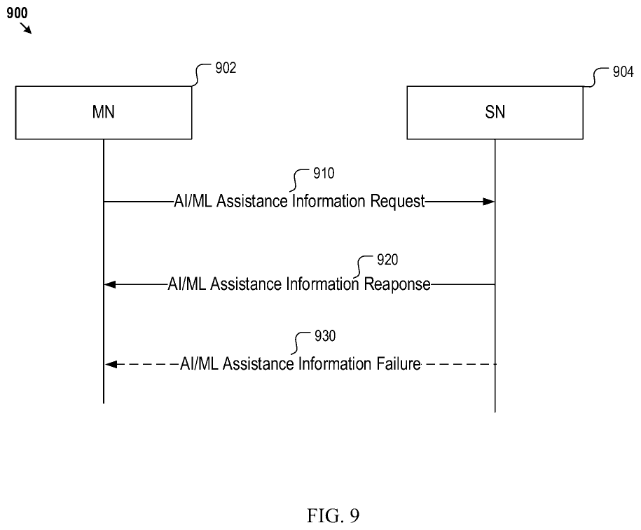

In some example implementation alternative to the above, a procedure may be designed for requesting AI/ML prediction information between the MN and the SN, as initiated by the SN rather than the MN. Such an example procedure is shown in 900 of FIG. 9. The MN-initiated AI/ML prediction information request procedure may include Step 1 (910), optional Step 2 (920), and optional Step 3 (930) for message exchange between the MN 902 and SN 904.

In Step 1, as shown in 910 of FIG. 8, the MN 902 may send an AI/ML Assistance Information Request Message to the SN 904, for requesting AI/ML predicted information from the SN 904. Such an AI/ML Assistance Information Request Message may, among other information items, include one or more of the following information items:
An identifier for the mobile terminal as assigned or allocated at the MN 902, e.g., an XnAP ID for the mobile terminal at the MN 902; and/or
A type for the requested AI/ML assistance information.

The type for the requested AI/MI assistance information may indicate a category of AI/MI assistant information that the MN 902 intends to request from the SN 904, and may indicate that the AI/MI assistant information items are the ones relevant to predicted UE trajectory.

In Step 2, as shown in 920 of FIG. 9, the SN 904, upon receiving the AI/ML Assistance Information Request Message, may determine whether it is configured or in a position to successfully provide the requested AI/MI assistance information. If the SN 904 determines that it is configured to in the position of successfully obtaining or generating the requested AI/ML assistance information, it then obtains or generates the requested AI assistance information via inference procedures and sends an AI/ML Assistance Information Response Message to the MN 902. Such an AI/ML Assistance Information Report Message may include and provide the request AI/ML assistance information items. The AI/ML Assistance Information Report Message, for example, may include at least one of the following information:
An identifier for the mobile terminal as assigned or allocated at the SN 904, e.g., an XnAP ID for the mobile terminal at the SN 904;
An identifier for the mobile terminal as assigned or allocated at the MN 902, e.g., an XnAP ID for the mobile terminal at the MN 902; and/or
The AI/ML predicted information items relevant to the trajectory of the mobile terminal.

The AI/ML predicted information items relevant to the trajectory of the mobile terminal may include the following prediction information related to the SN 904 or a target SN:
A predicted Target S-NG-RAN node List;
A predicted PSCell List for the SN or a target SN; and/or
A predicted UE location List.

The Predicted PSCell List may be relevant to current SN 904 or the target SN, and, for example, may further include one or more the information items pertaining to the SN 904 or the target SN as described above in relation to FIG. 4. Likewise, the predicted PCell List for the MN 904 and Predicted UE location List, for example, may further include one or more of the information items described above in relation to FIG. 4.

Optionally or alternatively in Step 3, as shown by 930 of FIG. 9, if the SN 904 determines that it is not in a position or is not configured to successfully obtain or generate the request AI/ML assistance information items, it then sends an AI/ML Assistance Information Failure message to the MN 902.

Further in summary, the various embodiments above disclose that, in dual connectivity environment, an MN may be configured to provide AI/ML based predicted information to an SN for assisting the SN in perform resource and cell selection and configuration in order to optimize dual connectivity. The AI/ML based prediction information may include one or more of the following:
A predicted Target S-NG-RAN node List;
A predicted Target M-NG-RAN node List;
A predicted PSCell List, which involves at least one of the following information:
   Predicted PSCell IDs;
   A predicted arrival time of the UE at each predicted PSCell;
   A predicted duration time of UE staying in the PSCell;
   Probability of each predicted PSCell being a candidate PSCell; and/or
   Validity time, which means the predicted value is valid for a certain period of time;
Predicted PCell List, which involves at least one of the following information:
   Predicted PCell IDs;
   A predicted arrival time of the UE at each predicted PCell;
   A predicted duration time of UE staying in the PCell;
   Probability of each predicted PCell being a candidate PCell; and/or
   Validity time, which means the predicted value is valid for a certain period of time; and/or
Predicted UE location List, which involves at least one of the following information:
   Predicted UE coordinates in the future;
   A predicted arrival time of the UE at each predicted UE coordinates;
   A predicted duration time of UE staying in the coordinates;
   Confidence of each predicted future coordinate; and/or
   Validity time, which means the predicted value is valid for a certain period of time.

Additionally, one of the following messages from MN to SN can be used to carry the AI/ML based information above:
SN Addition Request message;
SN Modification Request Message;
AI/ML Assistance information Report message.

Additionally, in some embodiments above, the MN may provide an AI/ML based assistance information allowed Indicator, to indicate to the SN whether the SN needs to provide the AI/ML based predicted information to the MN.

In some embodiments, the request message from MN to SN may indicate Requested AI/ML assistance information type, which may indicate that the requested AI/ML assistance information is for predicting UE trajectory.

In some embodiments, the SN may provide the AI/ML based predicted information related to a target SN to MN. Such AI/ML based prediction information may involve the following information:
A predicted Target S-NG-RAN node List;
A predicted PSCell List, which involves at least one of the following information:
   Predicted PSCell IDs;
   A predicted arrival time of the UE at each predicted PSCell;
   A predicted duration time of the UE staying in the PScell;
   Probability of each predicted PSCell being a candidate PSCell; and/or
   Validity time, which means the predicted value is valid for a certain period of time; and/or
Predicted UE location List, which involves at least one of the following information:
   Predicted UE coordinates in the future;
   A predicted arrival time of the UE at each predicted UE coordinate;
   Predicted duration time of UE staying in the current UE coordinate;
   Confidence of each predicted future coordinate; and/or
   Validity time, which means the predicted value is valid for a certain period of time.

In some embodiments, one of the following messages from SN to MN may be used to carry the AI/ML based information above:
SN Modification Required Message;
SN Change Required Message;
SN Release Required message; or
SN Release Required message.

In some embodiments, a procedure is designed to transfer the predicted information between SN and MN, including the request message, response message, and failure message, as described in detail above.

In some embodiments, the SN may provide the AI/ML based assistance information allowed Indicator for indicating to the MN whether the MN needs to provide the AI/ML based predicted information to the SN.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a first base station (BS) for supporting a dual over-the-air connectivity (DOTA), in conjunction with a second BS, to a wireless terminal, the first BS and the second BS being respectively one and another of a master node (MN) and a secondary node (SN), and the method comprising:
transferring a first network configuration prediction information in an inter-BS message to the second BS to assist the second BS with the DOTA with the wireless terminal, the inter-BS message carrying the first network configuration prediction information,
wherein the first network configuration prediction information comprises at least one of:
predicted PSCell information of the SN or a target SN for the DOTA with the wireless terminal;
predicted PCell information of the MN for the DOTA with the wireless terminal;
predicted location information of the wireless terminal;
a predicted target S-NG-RAN node list; or
a predicted target M-NG-RAN node list.

2. The method of claim 1, wherein the predicted PSCell information of the SN comprises at least one of:
a list of identifiers for predicted PSCells of the SN for the DOTA;
predicted arrival times for the predicted PSCells;
predicted duration time of the wireless terminal staying in the PSCells;
predicted probability of each of the predicted PSCells being used for the DOTA; or
a validity time length during which the predicted PSCell information is effective.

3. The method of claim 1, wherein the predicted PCell information of the MN comprises at least one of:
a list of identifiers for predicted PCells of the MN for the DOTA;
predicted arrival times for the predicted PCells;
predicted duration time of the wireless terminal staying in the predicted PCells;
predicted probability of each of the predicted PCells being used for the DOTA; or
a validity time length during which the predicted PCell information is effective.

4. The method of claim 2, wherein the predicted location information of the wireless terminal comprises at least one of:
predicted future coordinates of the wireless terminal;
a predicted arrival time of the wireless terminal;
a predicted duration time of the wireless terminal staying in current coordinates;
a confidence level of each predicted future coordinate; or
a validity time length during which the predicted location information of the wireless terminal is effective.

5. The method of claim 1, wherein the first BS is the MN and the second BS is the SN.

6. The method of claim 5, wherein:
the inter-BS message is constructed as an SN-addition request for requesting the SN to allocate resources for the DOTA; or
the inter-BS message is constructed as an SN-modification request for requesting the SN to modify either a context of the wireless terminal at the SN or to modify resources for the DOTA.

7. (canceled)

8. The method of claim 5, wherein the inter-BS message further comprises an indicator for indicating to the SN whether the SN is to provide a second network configuration prediction information to the MN.

9. The method of claim 1, wherein the first BS is the SN and the second BS is the MN.

10. The method of claim 9, wherein:
the inter-BS message is constructed as an SN-change request for requesting the MN to switch to the target SN;
the inter-BS message is constructed as an SN-modification request for initiating either a context modification of the wireless terminal or a resource modification for the DOTA at the SN; or
the inter-BS message is constructed as an SN-initiated SN-release request.

11. The method of claim 10, wherein the inter-BS message further comprises an identifier of the target SN.

12. (canceled)

13. The method of claim 9, wherein the inter-BS message further comprises an indicator for indicating to the MN whether the MN is to provide a second network configuration prediction information to the SN.

14. The method of claim 9, wherein the method further comprises receiving an SN-release request from the MN (the second BS) for initiating a release of resources at the SN for the wireless terminal prior to the SN (the first BS) transmitting the inter-BS message.

15. The method of claim 14, wherein the inter-BS message is constructed as a response to the SN-release request.

16. (canceled)

17. A method performed by a first base station (BS) for supporting a dual over-the-air connectivity (DOTA), in conjunction with a second BS, to a wireless terminal, the first BS and the second BS being respectively one and another of a master node (MN) and a secondary node (SN), and the method comprising:
receiving a request message for Artificial Intelligence (AI) generated DOTA configuration assistance information;
in response to the request message and to determining that the first BS is successfully configured to generate the AI generated DOTA configuration assistance information as requested:
generating the AI generated DOTA configuration assistance information; and
transmitting a response message containing the AI generated DOTA configuration assistance information to the second BS; and
in response to the request message and to determining that the first BS fails to generate the AI generated DOTA configuration assistance information, transmitting a failure response to the second BS,
wherein the AI generated DOTA configuration assistance information comprises at least one of:
predicted PSCell information of the SN or a target SN for the DOTA with the wireless terminal;
predicted PCell information of the MN for the DOTA with the wireless terminal;
predicted location information of the wireless terminal;
a predicted target S-NG-RAN node list; or
a predicted target M-NG-RAN node list.

18. The method of claim 17, wherein the request message further comprises an identifier of the wireless terminal allocated by the first BS.

19. The method of claim 18, wherein the request message further comprises a type of the AI generated DOTA configuration assistance information.

20. The method of claim 19, wherein the type of the AI generated DOTA configuration assistance information comprises at least a predicted mobile terminal trajectory.

21. The method of claim 17, wherein:
the first BS is the MN and the second BS is the SN; and
the request message further comprises an XnAP ID allocated by the SN; or
the first BS is the SN and the second BS is the MN; and the request message further comprises an XnAP ID allocated by the MN.

22. (canceled)

23. The first BS, comprising a memory for storing instructions and a processor for executing the instructions to implement the method of claim 1.

24. (canceled)

25. The first BS, comprising a memory for storing instructions and a processor for executing the instructions to implement the method of claim 17.
